(19) United States
(12) Patent Application Publication
(10) Pub. No.: US 2024/0295628 A1
(43) Pub. Date: Sep. 5, 2024

(54) RADAR SIGNAL PROCESSING APPARATUS AND RADAR SIGNAL PROCESSING METHOD

(71) Applicant: Samsung Electronics Co., Ltd., Suwon-si, Gyeonggi-do (KR)

(72) Inventors: Jeonghoon PARK, Suwon-si (KR); Seongcheol KIM, Seoul (KR)

(73) Assignees: Samsung Electronics Co., Ltd., Suwon-si, Gyeonggi-do (KR); SEOUL NATIONAL UNIVERSITY R&DB FOUNDATION, Seoul (KR)

(21) Appl. No.: 18/591,789

(22) Filed: Feb. 29, 2024

(30) Foreign Application Priority Data
Mar. 3, 2023 (KR) 10-2023-0028759

(51) Int. Cl. G01S 7/02; G01S 7/41; G01S 13/58

(52) U.S. Cl. CPC G01S 7/0232; G01S 7/418; G01S 13/584

(57) ABSTRACT

Provided is a radar signal processing method based on Orthogonal Frequency Division Multiplexing (OFDM). The method includes transmitting an OFDM transmission signal to at least one target, receiving an analog reception signal reflected from the at least one target, converting the analog reception signal into a digital reception signal, obtaining a first velocity of the at least one target based on the digital reception signal, and processing the digital reception signal based on the first velocity to obtain a recovery signal having reduced inter-channel interference.

### CROSS-REFERENCE TO RELATED APPLICATION

This application is based on and claims priority under 35 U.S.C. § 119 to Korean Patent Application No. 10-2023-0028759, filed on Mar. 3, 2023, in the Korean Intellectual Property Office, the disclosure of which is incorporated by reference herein in its entirety.

### BACKGROUND

The inventive concepts relate to a radar signal processing method, and more particularly, to a radar signal processing method based on Orthogonal Frequency Division Multiplexing (OFDM) and a radar signal processing apparatus.

A communication radar compatibility system may perform both communication and radar functions using one signal. For example, a communication radar compatibility system may perform a radar function by transmitting a signal used for communication and then measuring a signal reflected from a target. Among communication radar compatibility systems, there is an OFDM communication radar compatibility system. Here, OFDM refers to a digital modulation method using a carrier frequency. The OFDM communication radar compatibility system transmits an OFDM signal to a target and then processes the signal reflected from the target to estimate the distance and velocity of the target. However, since the OFDM signal is a signal wave designed to suit a communication function, the radar function may be deteriorated due to the design characteristics of the signal wave. There have been attempts to improve the radar function in the conventional OFDM communication radar compatibility system, such as modifying the OFDM signal, but there is a negative tradeoff in that the communication function is deteriorated.

### SUMMARY

The inventive concepts provide a radar signal processing method and a radar signal processing apparatus based on Orthogonal Frequency Division Multiplexing (OFDM).

According to an aspect of the inventive concepts, there is provided a radar signal processing method based on OFDM, the method including transmitting an OFDM transmission signal to at least one target, receiving an analog reception signal reflected from the at least one target, converting the analog reception signal into a digital reception signal, obtaining a first velocity of the at least one target based on the digital reception signal, and processing the digital reception signal based on the first velocity to obtain a recovery signal having reduced inter-channel interference.

According to an aspect of the inventive concepts, there is provided a radar signal processing apparatus including processing circuitry configured to transmit an Orthogonal Frequency Division Multiplexing (OFDM) transmission signal to at least one target, receive an analog communication reception signal reflected from the at least one target, convert the analog communication reception signal into a digital reception signal, obtain a first velocity of the at least one target based on the digital reception signal, and process the digital reception signal based on the first velocity to obtain a recovery signal having reduced inter-channel interference.

According to an aspect of the inventive concepts, there is provided a computer-readable non-transitory storage medium storing instructions that, when executed by a processor, cause the processor to perform OFDM radar signal processing, the OFDM radar signal processing comprising transmitting an OFDM transmission signal to at least one target, receiving an analog reception signal reflected from the at least one target, converting the analog reception signal into a digital reception signal, obtaining a first velocity of the at least one target based on the digital reception signal, and processing the digital reception signal based on the first velocity to obtain a recovery signal having reduced inter-channel interference.

### BRIEF DESCRIPTION OF THE DRAWINGS

Embodiments will be more clearly understood from the following detailed description taken in conjunction with the accompanying drawings in which:

FIG. 1 is a diagram illustrating a communication radar compatibility system according to embodiments;

FIG. 2 is a flowchart illustrating a radar signal processing method according to embodiments;

FIG. 3 is a flowchart illustrating a coarse compensation operation according to embodiments;

FIG. 4 is a flowchart illustrating a fine compensation operation according to embodiments;

FIGS. 5A and 5B are diagrams illustrating distance velocity maps according to embodiments;

FIG. 6 is a diagram for explaining the reduction of the inter-carrier interference effect according to the radar signal processing method provided in embodiments; and

FIG. 7 is a diagram for explaining an autonomous driving system performing a radar signal processing method according to embodiments.

### DETAILED DESCRIPTION

Hereinafter, embodiments will be described in detail with reference to the accompanying drawings.

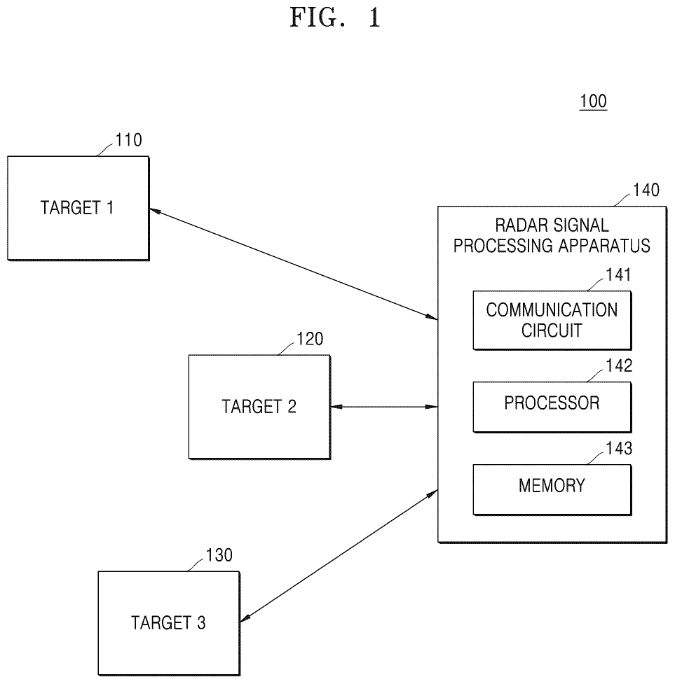

FIG. 1 is a diagram illustrating a communication radar compatibility system according to embodiments.

Referring to FIG. 1, an Orthogonal Frequency Division Multiplexing (OFDM) communication radar compatibility system 100 according to embodiments may include a first target 110, a second target 120, a third target 130, and/or a radar signal processing apparatus 140. The communication radar compatibility system 100 may include a radar signal processing apparatus 140 that performs communication and radar functions based on OFDM.

The first target 110 to the third target 130 may be objects to be measured for distance and/or velocity within the communication radar compatibility system 100. The first target 110 to the third target 130 may be moving means moving along a road or may be fixed objects. For example, the first target 110 to the third target 130 may be vehicles. Although FIG. 1 shows an example in which three targets, that is, the first targets 110 to third targets 130, are present in the communication radar compatibility system 100, one or more targets may be present in the communication radar compatibility system 100.

The radar signal processing apparatus 140 may include a communication circuit 141, a processor 142, and/or a memory 143.

The communication circuit 141 may support establishing a communication channel with the first target 110 to the third target 130 and performing communication through the established communication channel. In other words, the communication circuit 141 may communicate with the first target 110 to the third target 130. The communication circuit 141 may communicate with the first target 110 to the third target 130 based on OFDM. The communication circuit 141 may transmit an OFDM transmission signal to the first target 110 to the third target 130. Also, the communication circuit 141 may receive analog reception signals reflected from the first target 110 to the third target 130.

The communication circuit 141 may include one or more communication processors that operate independently of the processor 142 and support communication. For example, the communication circuit 141 may include a wireless communication module (e.g., a cellular communication module, a short-range wireless communication module, or a global navigation satellite system (GNSS) communication module) or a wired communication module (e.g., a local area network (LAN) communication module or a power line communication module). The communication circuit 141 may communicate with an external electronic device through a first network (e.g., short-range communication networks such as Bluetooth, WiFi direct, or infrared data association (IrDA)) or a second network (e.g., telecommunications networks such as a cellular network, the Internet, or a computer network (e.g., a local area network (LAN) or a wide-area network (WAN))). Various types of communication modules may be implemented with one component (e.g., a single chip) or a plurality of components (e.g., multiple chips).

The processor 142 may execute one or more instructions (software). The processor 142 may execute the one or more instructions to control other components (e.g., hardware or software components) included in the radar signal processing apparatus 140 and may perform various data processing or calculations. For example, the processor 142 may load instructions or data received from other components into volatile memory as at least part of data processing or operation, and may process instructions or data stored in volatile memory and store resulting data in non-volatile memory. As another example, the processor 142 may include a main processor (e.g., a central processing unit or an application processor) and a secondary processor (e.g., a graphics processing unit, an image signal processor, a sensor hub processor, or a communication processor) that may operate independently or together with the main processor. The secondary processor may be configured to use less power than the main processor or to be specialized for a designated function. The secondary processor may be implemented separately from the main processor or as part of the main processor.

The memory 143 may store one or more instructions. Also, the memory 143 may store a variety of data used by at least one component (e.g., the processor 142) of the radar signal processing apparatus 140. The data may include input data or output data for one or more instructions (software) and related instructions. The memory 143 may include a volatile memory or a non-volatile memory. The one or more instructions may be stored as software in the memory 143 and may include, for example, an operating system, middleware, or applications.

The radar signal processing apparatus 140 may estimate the positions and/or velocities of the first target 110 to the third target 130 based on the analog reception signal. However, to solve a velocity ambiguity challenge of the first target 110 to the third target 130, the radar signal processing apparatus 140 may perform a coarse compensation operation. In the inventive concepts, it is assumed that the distance ambiguity challenge, which is a challenge in which the distance of the target may not be determined (e.g., may be unable to be determined), does not occur.

The velocity ambiguity challenge may refer aliasing that occurs in the estimated velocity in the radar signal processing apparatus 140 that estimates the velocity of the first target 110 to the third target 130 using the analog reception signal. In other words, the velocity ambiguity challenge may refer to a challenge in which the actual velocity of the target among the different velocities estimated by the radar signal processing apparatus 140 may not be determined (e.g., may be unable to be determined).

The radar signal processing apparatus 140 may obtain distance velocity map candidates corresponding to the analog reception signal using an OFDM radar algorithm based on 2D Fast Fourier Transform (2D-FFT). More specifically, the OFDM radar algorithm may refer to an algorithm for obtaining distance velocity map candidates by Equation 4 described below. Through this, the radar signal processing apparatus 140 may estimate the distance and/or velocity of the target. However, when using the OFDM radar algorithm, the velocity range that the radar signal processing apparatus 140 may discriminate may be limited. For example, the range of velocity that the radar signal processing apparatus 140 may distinguish may be about −50 m/s to about 50 m/s. Using the OFDM radar algorithm, the radar signal processing apparatus 140 may not be able to distinguish a velocity outside the distinguishable velocity range from a velocity within the distinguishable range. In other words, aliasing may occur in the velocity estimated by the radar signal processing apparatus 140.

The radar signal processing apparatus 140 may not be able to distinguish a velocity that differs by a multiple of the difference between the maximum value (e.g., highest value) and the minimum value (e.g., lowest value) of the distinguishable velocity range, that is, a multiple of 100 m/s. For example, the radar signal processing apparatus 140 may not be able to distinguish between a case where the velocity of the first target 110 is 10 m/s and a case where the velocity is 110 m/s. In other words, even if the radar signal processing apparatus 140 estimates the velocity of the first target as 10 m/s, the actual velocity of the first target 110 may have an error by a multiple of 100 m/s. For example, the velocity of the first target 110 may be −90 m/s or 110 m/s. Therefore, even if the radar signal processing apparatus 140 estimates the velocity of the first target 110 as 10 m/s, the actual velocity of the target may not be determined.

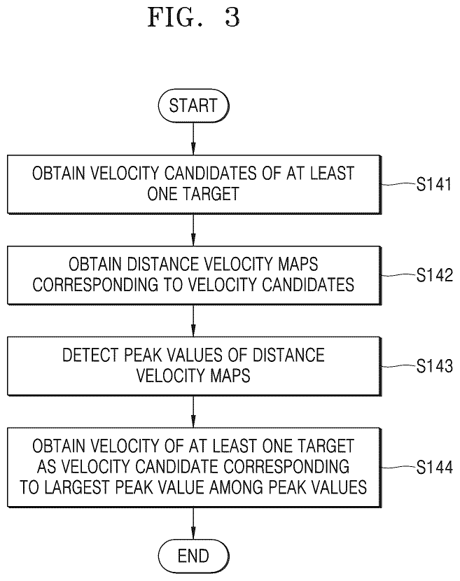

The coarse compensation operation may refer to an operation in which the radar signal processing apparatus 140 obtains an actual velocity of a target among different velocities that may be the velocity of the target. In other words, the radar signal processing apparatus 140 may obtain the actual velocity of the target without causing the velocity ambiguity challenge through the coarse compensation operation. Through this, the radar signal processing apparatus 140 may solve the velocity ambiguity challenge of the first target 110 to the third target 130 without modifying the OFDM transmission signal. A more detailed description of the coarse compensation operation is described below with reference to FIG. 3.

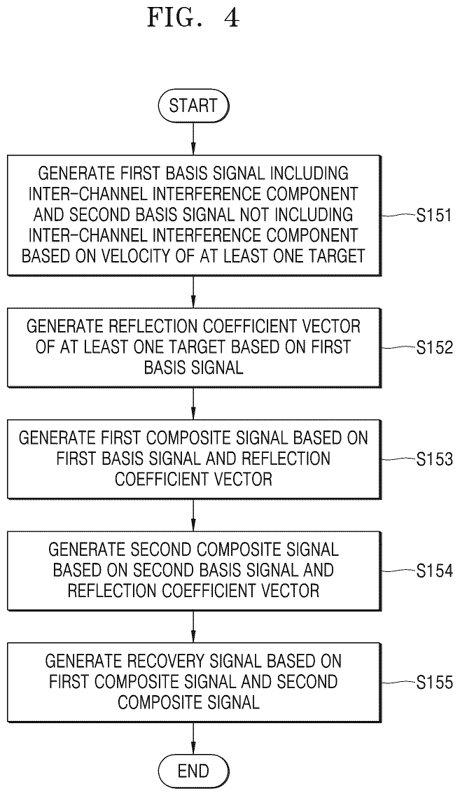

In addition, to reduce the effect of inter-carrier interference, the radar signal processing apparatus 140 may perform a fine compensation operation. As shown in FIG. 1, analog reception signals reflected from each of the first target 110 to the third target 130 may reach the radar signal processing apparatus 140 through different channels. At this time, respective analog reception signals may interfere with each other. The fine compensation operation may refer to an operation to reduce an inter-carrier interference effect based on actual velocities of the first target 110 to the third target 130 obtained through the coarse compensation operation. The radar signal processing apparatus 140 may reduce the effect of inter-carrier interference through a fine compensation operation and may increase the signal-to-noise ratio of the first target 110 to the third target 130. A more detailed description of the fine compensation operation is described below with reference to FIG. 4.

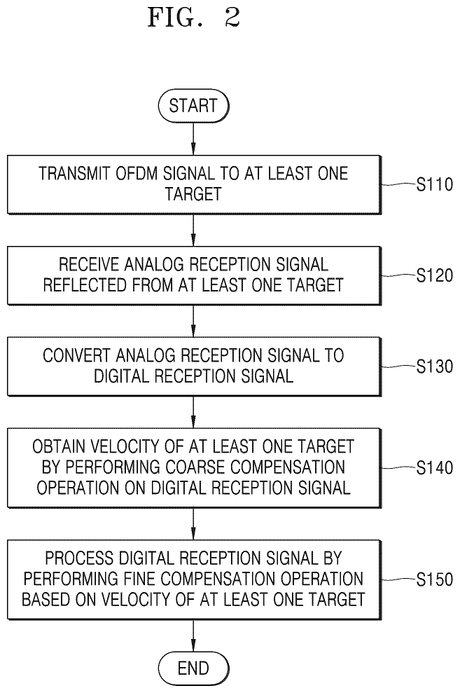

FIG. 2 is a flowchart illustrating a radar signal processing method according to embodiments. FIG. 2 may be described with reference to FIG. 1. According to embodiments, the operations of FIG. 2 may be performed by the radar signal processing apparatus 140 discussed in connection with FIG. 1.

A radar signal processing method according to embodiments may include operations S110 to S150.

An OFDM signal may be transmitted to at least one target in operation S110. For example, referring to FIG. 1, OFDM signals may be transmitted to at least one among the first target 110 to the third target 130. An OFDM signal may refer to a transmission signal for performing communication based on OFDM.

In operation S120, an analog reception signal reflected from the target (e.g., the analog reception signal reflected from at least one target among the first target 110 to the third target 130) may be received. For example, analog reception signals reflected from the first target 110 to the third target 130 of FIG. 1 may be received. The analog reception signals may have different arrival times and frequencies depending on the positions and velocities of the first target 110 to the third target 130.

In operation S130, an analog reception signal may be converted into a digital reception signal.

In embodiments, an analog reception signal may be converted into a digital reception signal by an analog-to-digital converter (not shown). A digital reception signal may be expressed as Equation 1 below based on 2D-FFT. Specifically, a digital reception signal based on 2D-FFT may be represented by an N_C XN_S matrix Y.

$$y ∈ {ℂ}^{{N}_{C} XN} , {[ Y ]}_{μ , m} = y [ μ , m ] \qquad [ Equation 1 ]$$

In Equation 1 and below, Times New Roman represents the number of carriers, Times New Roman represents the number of symbols in one frame, [symbol] ^{N}^{_{C}}^{XN}^{_{S}} represents the Times New Roman complex plane, and Times New Roman represents the Times New Roman-th sampled signal from the m-th symbol.

In operation S140, the target velocity (e.g., at least one target velocity of at least one target among the first target 110 to the third target 130) may be obtained by performing a coarse compensation operation on the digital reception signal. The coarse compensation operation may refer to an operation of obtaining target velocity candidates corresponding to a digital reception signal (e.g., a plurality of target velocity candidates corresponding to each of the at least one target) and determining the target velocity as a velocity candidate having the highest signal intensity among the velocity candidates. Since the velocity of the target is determined according to operation S110 through operation S140, the velocity ambiguity challenge may be solved or reduced.

In operation S150, a digital reception signal may be processed by performing a fine compensation operation based on the velocity of the target (e.g., the at least one target velocity). In operation S150, a digital reception signal may be processed based on the velocity of the target for which the velocity ambiguity challenge has been resolved or reduced.

Specifically, a reflection coefficient vector may be estimated in operation S152 of FIG. 4 to reconstruct a signal for each target as described below. In addition, a digital reception signal may be processed by restoring a signal in which an inter-carrier interference effect is compensated for using a reflection coefficient vector.

FIG. 3 is a flowchart illustrating a coarse compensation operation according to embodiments.

The coarse compensation operation shown in FIG. 3 may be an example of operation S140 of FIG. 2. The discussion of FIGS. 3 and 4 refers to a target, however embodiments are not limited to a single target. According to embodiments, the operations of FIG. 3 may be performed with respect to each target among at least one of the first target 110 to the third target 130.

In operation S141, target velocity candidates may be obtained.

In embodiments, velocity candidates of the target may be obtained based on Equation 2 below.

$${v}_{a} = v + 2 * Z * {v}_{amb} \qquad [ Equation 2 ]$$

In Equation 2 and below, vₐ represents the velocity candidates of the target, v represents the velocity of the target estimated according to the OFDM radar algorithm based on 2D-FFT, Z represents an arbitrary integer, and v_{amb} represents the ambiguous velocity. According to embodiments, operation S141 may include performing the OFDM radar algorithm based on 2D Fast Fourier Transform (2D-FFT) discussed in connection with FIG. 1 to obtain v and/or v_{amb}.

Here, an arbitrary integer Z may be expressed according to Equation 3 below for an arbitrary natural number Nₐ.

$$Z ∈ \{ - {N}_{a} , - {N}_{a} + 1 , … , {N}_{a} \} \qquad [ Equation 3 ]$$

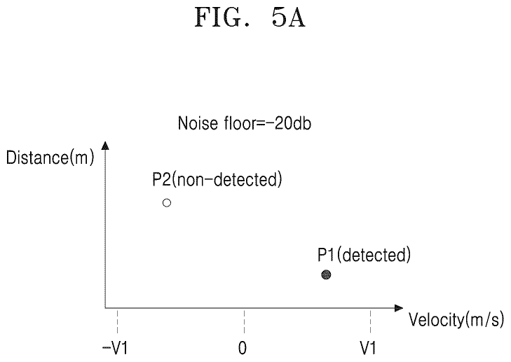

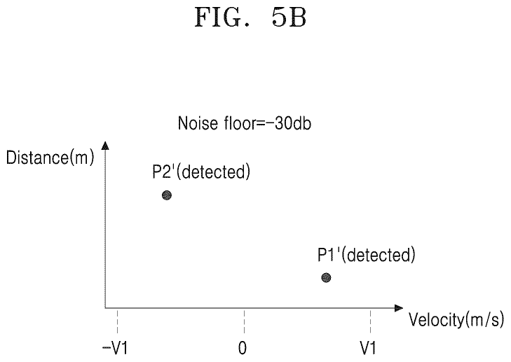

An ambiguous velocity may refer to the maximum value (e.g., the highest value) of a range of distinguishable velocities. For example, when the velocity range of a target that may be distinguished by the radar signal processing apparatus is about −50 m/s to about 50 m/s, the ambiguous velocity may be the maximum value (e.g., the highest value) of the distinguishable velocity range, that is, 50 m/s. Also, the ambiguous velocity may refer to the maximum velocity (e.g., the highest velocity) shown in the distance velocity maps as depicted in FIGS. 5A and 5B. Also, the ambiguous velocity may be referred to as the maximum distinguishable velocity (e.g., the highest distinguishable velocity).

In operation S142, distance velocity map candidates corresponding to the velocity candidates may be obtained.

In embodiments, distance velocity map candidates may be obtained based on Equation 4 below. Also, the OFDM radar algorithm may refer to an algorithm for obtaining distance velocity map candidates based on Equation 4.

$$G ( Z ) = {F}_{{N}_{C}}^{- 1} ( ( {F}_{{N}_{C}} {D}_{{N}_{C}} ( - \frac{Z}{α * {N}_{C}} ) Y ) X ) {F}_{{N}_{S}} \qquad [ Equation 4 ]$$

In Equation 4 and below, a represents the length ratio of 1+CP (cyclic prefix (e.g., of the OFDM signal transmitted in operation S110)), D_(N_C) represents a matrix according to Equation 5 below, F_(N_S) and F_(N_C) represent matrices according to Equation 6 below, [symbol] F_(N_C) [symbol] \hat{ }(−1) represents the inverse matrix of F_(N_C), X represents a 2D-FFT matrix of the transmission signal, Y represents a 2D-FFT matrix of the reception signal (e.g., the digital reception signal), and [symbol] represents an elementwise division operator. X may refer to, for example, a 2D-FFT matrix of the OFDM signal transmitted in operation S110 of FIG. 2.

$${D}_{N} ( f ) = [ \begin{matrix}1 & 0 & … & 0 \\ 0 & {e}^{j 2 π f} & … & 0 \\ ⋮ & ⋮ & ⋱ & ⋮ \\ 0 & 0 & … & {e}^{j 2 π f ( N - 1 )}\end{matrix} ] ∈ {ℂ}^{N \times N} . \qquad [ Equation 5 ]$$

$${F}_{N} = \frac{1}{\sqrt{N}} [ {e}^{- j 2 π \frac{kn}{N}} ] \begin{matrix}0 \leq k < N \\ 0 \leq n < N\end{matrix} ∈ {ℂ}^{N \times N} \qquad [ Equation 6 ]$$

In Equations 5 and 6 and below, each of k and n represents an integer greater than or equal to 0 and less than N, and N represents a natural number. Also, F_{N} of Equation 6 may be referred to as a Discrete Fourier Transform (DFT) matrix.

Peak values of distance velocity map candidates may be detected in operation S143. Among pixel values included in the distance velocity map candidates, pixel values having a larger peak than adjacent pixel values may be detected. Here, pixel values may mean elements of a matrix G(Z) representing distance velocity map candidates. According to embodiments, peak values are detected in only a subset of the elements of the matrix G(Z).

In embodiments, peak values may be detected according to a known Cell Averaging-Constant False Alarm Rate (CA-CFAR) algorithm. However, this is only an example, and a method of detecting a peak value may be determined differently according to embodiments.

In operation S143, the obtained peak values may be expressed as in Equation 7 below.

$$T = \{ ( {t}_{r ( 0 )} , {t}_{v ( 0 )} ) , ( {t}_{r ( 1 )} , {t}_{v ( 1 )} ) , … , ( {t}_{r ( \vert T \vert - 1 )} , {t}_{v ( \vert T \vert - 1 )} ) \} \qquad [ Equation 7 ]$$

In Equation 7 and below, tᵣ₍ᵢ₎ represents a pixel of a distance value of the i-th target, tᵥ₍ᵢ₎ represents a pixel of a velocity value of the i-th target, and |T| represents the number of elements of the set T. |T| may correspond to the number of targets. According to embodiments, i may represent an integer.

In operation S144, the velocity of the target may be obtained as a velocity candidate (e.g., among the velocity candidates obtained in operation S141) corresponding to the largest peak value among peak values. For example, among the distance velocity map candidates according to an arbitrary integer Z, peak values may be detected in elements of row 3, column 5 and row 7, column 2. When Z is 0, the element of row 3 and column 5 of the distance velocity map candidate is 0.8, and when Z is 1, the element of row 3 and column 5 of the distance velocity map candidate may be 0.5, and if Z is −1, the element of row 3 and column 5 of the distance velocity map candidate may be 1.2. Among the respective Z values, when Z is −1, the element in row 3 and column 5 is the largest, so the element in row 3 and column 5 of the distance velocity map may be obtained when Z is −1. In other words, the velocity of the target corresponding to row 3 and column 5 of the distance velocity map may be obtained when Z is −1. According to embodiments, for instance, in this example the velocity of the target may be 1.2.

Similarly, if Z is 0, the element of row 7 and column 2 of the distance velocity map candidate may be −0.3, and if Z is 1, the element of row 7 and column 2 of the distance velocity map candidate may be 3.2, and if Z is −1, the element of the row 7 and column 2 of the distance velocity map candidate may be 2. Among the respective Z values, when Z is 1, the element in row 7 and column 2 is the largest, so the element in row 7 and column 2 of the distance velocity map may be obtained when Z is 1. In other words, the velocity of the target corresponding to row 7 and column 2 of the distance velocity map may be obtained when Z is 1. According to embodiments, for instance, in this example the velocity of the target may be 3.2.

The distance velocity map obtained in operation S144 may be generated with the largest value among components of each distance velocity map candidate. In other words, the distance velocity map may include the largest peak values among peak values included in the distance velocity map candidates. The distance velocity map may be referred to as G(0) below.

FIG. 4 is a flowchart illustrating a fine compensation operation according to embodiments.

In operation S151, a first basis signal including an inter-carrier interference component (may also be referred to herein as an inter-channel interference component) and a second basis signal not including an inter-carrier interference component may be generated based on the velocity of the target.

In embodiments, the first basis signal may be generated based on Equation 8 below.

$${Y}_{C}^{( i )} = \frac{1}{\sqrt{{N}_{C}}} {D}_{{N}_{C}} ( \frac{{f}_{i}^{( D )}}{{N}_{C}} ) {F}_{{N}_{C}}^{- 1} {D}_{{N}_{C}} ( - {τ}_{i} ) {XD}_{{N}_{S}} ( α * {f}_{i}^{( D )} ) , i = 0 , 1 , … , \vert T \vert - 1 \qquad [ Equation 8 ]$$

In Equation 8 and below, Y_{C}⁽ⁱ⁾ represents the first basis signal, fᵢ^{(D)} represents the normalized velocity component of the i-th target, τᵢ represents the normalized distance component of the i-th target, and X represents a 2D-FFT matrix of the transmission signal. For example, X represents a 2D-FFT matrix of the OFDM signal transmitted in operation S110 of FIG. 2. fᵢ^{(D)} may be expressed as in Equation 9 below, and τᵢ may be expressed as in Equation 10 below. In Equation 8, D_{N}_{_{C}}(N_{C}/fᵢ^{(D)}) may be referred to as an inter-carrier interference component.

$${f}_{i}^{( D )} = \frac{2 * {f}_{c} * {v}_{i}}{{c}_{0}} , i = 0 , 1 , … , \vert T \vert - 1 \qquad [ Equation 9 ]$$

In Equation 9 and below, c₀ represents the velocity of light, f_{c} represents the transmission frequency (e.g., of the OFDM signal transmitted in operation S110), and vᵢ represents the actual velocity of the i-th target. vᵢ may mean the velocity of the target abtained in operation S144.

$${τ}_{i} = \frac{2 * {d}_{i}}{{c}_{0}} * {f}_{s} , i = 0 , 1 , … , \vert T \vert - 1 \qquad [ Equation 10 ]$$

In Equation 10 and below, dᵢ represents the distance of the i-th target and fₛ represents the subcarrier spacing (e.g., of the OFDM signal transmitted in operation S110).

In embodiments, the second basis signal may be generated based on Equation 11 below. Comparing Equation 8 to Equation 11, unlike Equation 8, Equation 11 does not include D_{N}_{_{C}}(N_{C}/fᵢ^{(D)}). Accordingly, the second basis signal (Y_{R}⁽ⁱ⁾) of Equation 11 may not include an inter-carrier interference component.

$${Y}_{R}^{( i )} = \frac{1}{\sqrt{{N}_{C}}} {F}_{{N}_{C}}^{- 1} {D}_{{N}_{C}} ( - {τ}_{i} ) {XD}_{{N}_{S}} ( α * {f}_{i}^{( D )} ) , i = 0 , 1 , … , \vert T \vert - 1 \qquad [ Equation 11 ]$$

In operation S152, a target reflection coefficient vector may be generated based on the first basis signal.

In embodiments, the reflection coefficient vector may be generated based on Equation 12 below.

$$\vec{a} = {( {Q}^{T} Q )}^{- 1} {Q}^{T} \vec{q} \qquad [ Equation 12 ]$$

In Equations 12 and below, the target peak cell vector \vec{q} may be generated based on Equation 13 below and the matrix Q may be generated based on Equation 14 below. The matrix Q^{T} may refer to a transpose matrix of the matrix Q.

$$\vec{q} ∈ {ℂ}^{\vert T \vert X 1} , {[ \vec{q} ]}_{i} = {[ G ( 0 ) ]}_{( {t}_{r ( i )} , {t}_{v ( i )} )} , i = 0 , 1 , … , \vert T \vert - 1 \qquad [ Equation 13 ]$$

In Equation 13, G(0) may refer to a distance velocity map obtained in operation S144 of FIG. 3. Times New Roman may refer to a vector composed of peak values included in the distance velocity map.

Times New Roman [Equation 14]

In Equation 14 and below, the target peak cell vector qc including the inter-carrier interference component may be generated based on Equation 15 below.

Cambria Math [Equation 15]

In Equation 15 and below, the distance velocity map G_{c}⁽ⁱ⁾ including the inter-carrier interference component may be generated based on Equation 16 below.

$${G}_{c}^{( i )} = {F}_{{N}_{C}}^{- 1} ( ( {F}_{{N}_{C}} {Y}_{c}^{( i )} ) X ) {F}_{{N}_{S}} , i = 0 , 1 , … , \vert T \vert - 1 \qquad [ Equation 16 ]$$

In operation S153, a first composite signal may be generated based on the first basis signal and the reflection coefficient vector.

In embodiments, the first composite signal may be generated based on Equation 17 below.

$${Y}_{C} = {{\sum }^{\vert T \vert - 1}}_{i = 0} {a}_{i} {Y}_{C}^{( i )} \qquad [ Equation 17 ]$$

In Equation 17 and below, Y_{C} represents the first composite signal, and aᵢ may mean the i-th component of the reflection coefficient vector \vec{a}.

In operation S154, the second composite signal may be generated based on the second basis signal and the reflection coefficient vector. In embodiments, the second composite signal may be generated based on Equation 18 below.

$${Y}_{R} = {{\sum }^{\vert T \vert - 1}}_{i = 0} {a}_{i} {Y}_{R}^{( i )} \qquad [ Equation 18 ]$$

In operation S155, a recovery signal may be generated based on the first composite signal and the second composite signal.

In embodiments, the recovery signal may be generated according to Equation 19 below.

$${Y}_{RC} = Y - {Y}_{C} + {Y}_{R} \qquad [ Equation 19 ]$$

FIGS. 5A and 5B are diagrams illustrating distance velocity maps according to embodiments. FIGS. 5A and 5B may be described with reference to FIG. 1.

FIG. 5A may represent a distance velocity map when a fine compensation operation is not performed, and FIG. 5B may represent a distance velocity map after a fine compensation operation is performed. In FIGS. 5A and 5B, the minimum velocity (e.g., the lowest velocity) that the radar signal processing apparatus may distinguish may be −V1 and the maximum velocity (e.g., the highest velocity) that the radar signal processing apparatus may distinguish may be V1.

Referring to FIG. 5A, the first point P1 is detected on the distance velocity map, but the second point P2 may not be detected due to the influence of the noise floor. Each of the first point P1 and the second point P2 may be illustratively any one of the first target 110 to the third target 130 of FIG. 1. The noise floor may mean the strength of signals corresponding to all signals other than the signal reflected from the target within the communication radar compatibility system 100. In other words, when the strength of the noise floor is higher, it may mean that signals other than the signal reflected from the target have a larger influence. For example, when the effect of inter-carrier interference is larger, the strength of the noise floor may increase. Compared to the case of FIG. 5B, the strength of the noise floor in FIG. 5A may be greater and as a result, the second point P2 may not be detected. According to embodiments, first point P1′ and second point P2′ illustrated in FIG. 5B may correspond to the first point P1 and the second point P2 illustrated in FIG. 5A, respectively.

Referring to FIG. 5B, the strength of the noise floor may be reduced by performing a fine compensation operation. In other words, the effect of inter-carrier interference may be reduced through the fine compensation operation. Accordingly, the second point P2′ not detected in FIG. 5A may be detected.

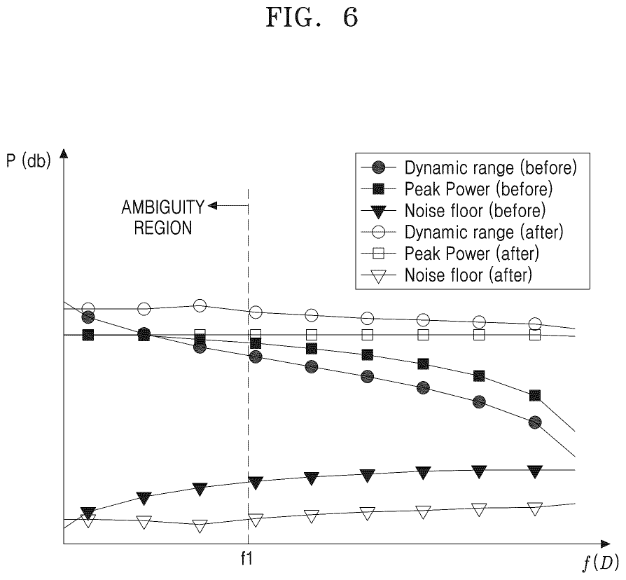

FIG. 6 is a diagram for explaining the reduction of the inter-carrier interference effect according to the radar signal processing method according to embodiments. FIG. 6 may be described with reference to FIGS. 1 and 4. FIG. 6 shows the strength of a signal according to the normalized velocity component described above in Equation 9 of FIG. 4. FIG. 6 may indicate, for example, the strength of a signal according to a normalized velocity component for the first target 110.

FIG. 6 shows a dynamic range, peak power, and noise floor before fine compensation operation is performed, and a dynamic range, peak power, and noise floor after fine compensation operation is performed. Here, the peak power may refer to signal strength of peak values, and the dynamic range may refer to a value obtained by subtracting a noise floor from peak power.

Referring to FIG. 6, the strength of the noise floor may be reduced by performing a fine compensation operation. Also, peak power and dynamic range may be increased. In other words, since the effect of noise is reduced and the strength of the signal is increased, the effect of inter-carrier interference may be reduced through the fine compensation operation.

The first velocity component f1 of FIG. 6 may correspond to a maximum velocity (e.g., a highest velocity) distinguishable by the radar signal processing apparatus 140. In other words, when the maximum velocity (e.g., the highest velocity) that the radar signal processing apparatus 140 may distinguish is 50 m/s, the first velocity component f1 may refer to a value obtained by converting 50 m/s into a normalized velocity component according to Equation 9.

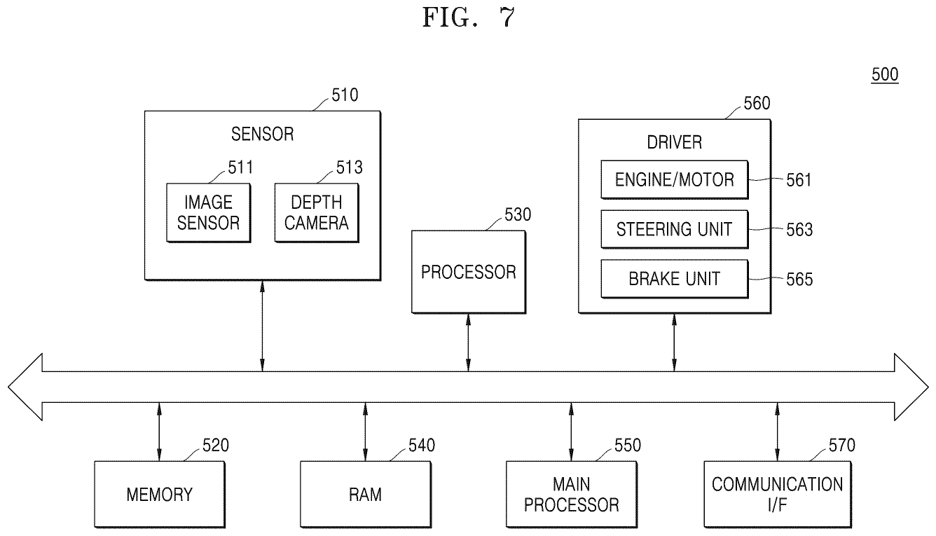

FIG. 7 is a diagram for explaining an autonomous driving system performing a radar signal processing method according to embodiments.

Referring to FIG. 7, an autonomous driving device 500 may include a sensor 510, a memory 520, a processor 530, RAM 540, a main processor 550, a driver 560, and/or a communication interface 570, and such components of the autonomous driving device 500 may be communicatively connected to each other through a bus. In this case, the memory 520 may correspond to the memory 143 of the above-described examples, and the processor 530 may correspond to the processor 142 of the above-described examples. In embodiments, the memory 520 and the processor 530 may be implemented using the examples described above with reference to FIGS. 1 to 6.

The sensor 510 may include a plurality of sensors that generate information about the surrounding environment of the autonomous driving device 500. For example, the sensor 510 may include a plurality of sensors that receive image signals related to the surrounding environment of the autonomous driving device 500 and output the received image signals as images. The sensor 510 may include an image sensor 511, such as a charge coupled device (CCD) or a complementary metal oxide semiconductor (CMOS), a depth camera 513, and/or the like. In embodiments, the image sensor 511 may generate a forward image of the autonomous driving device 500 and provide the generated forward image to the processor 530.

The memory 520 is a storage place for storing data, and may store various types of data generated in the process of performing calculations by the main processor 550 and the processor 530, for example.

As described above with reference to FIGS. 1 to 6, the processor 530 may convert the analog reception signal into a digital reception signal and perform coarse compensation operation and/or fine compensation operation on the digital reception signal to process digital reception signals.

The main processor 550 may control the overall operation of the autonomous driving device 500. For example, the main processor 550 may control functions of the processor 530 by executing programs stored in the RAM 540. The RAM 540 may temporarily store programs, data, applications, or instructions.

Also, the main processor 550 may control the operation of the autonomous driving device 500 based on an operation result of the processor 530. According to embodiments, the main processor 550 may receive information about the position and/or velocity of the target from the processor 530 (e.g., based on the coarse compensation operation and/or fine compensation operation) and control the operation of the driver 560 based on the information about the received position and/or velocity.

The driver 560 is a component for driving the autonomous driving device 500 and may include an engine and motor 561, a steering unit 563, and/or a brake unit 565. In embodiments, the driver 560 may adjust the propulsion, braking, speed, direction, etc. of the autonomous driving device 500 using the engine and motor 561, the steering unit 563 and/or the brake unit 565 under the control of the processor 530. According to embodiments, the engine and motor 561, the steering unit 563 and/or the brake unit 565 may be implemented using a physical engine and/or motor, steering system, and/or braking system. According to embodiments, the engine and motor 561, the steering unit 563 and/or the brake unit 565 may correspond to hardware and/or a combination of software and hardware for use in controlling the adjustment of the propulsion, braking, speed, direction, etc. of the autonomous driving device 500.

The communication interface 570 may perform communication with an external device using a wired and/or wireless communication method. For example, the communication interface 570 may perform communication using a wired communication method such as Ethernet or a wireless communication method such as Wi-Fi or Bluetooth.

In embodiments, the communication interface 570 may transmit an OFDM transmission signal and receive an analog communication reception signal reflected from a target, as described above with reference to FIGS. 1 to 6.

Conventional devices and methods for performing radar functions using OFDM communication signals experience inter-channel interference in the received signals reflected back from a target to the radar functions. In the conventional devices and methods, this inter-channel interference causes an excessive reduction in the peak intensity of the target, and excessive noise, within the received signals. Accordingly, a detection result (e.g., a distance and speed) of the radar functions provided by the conventional devices and methods may have an insufficient signal-to-noise ratio that may result in non-detection of a target.

However, according to embodiments, improved devices and methods are provided for performing radar functions using OFDM communication signals. For example, the improved devices and methods may obtain a velocity of a target by performing a coarse compensation operation using a received signal reflected back from a target. The velocity may be used to perform a fine compensation operation to reduce inter-channel interference. Accordingly, the improved devices and methods overcome the deficiencies of the conventional devices and methods to at least increase the signal-to-noise ratio of the radar detection result, thereby improving the quality of the result, and decreasing a likelihood of a non-detection of the target, without modifying the OFDM communication signals transmitted.

According to embodiments, operations described herein as being performed by the OFDM communication radar compatibility system 100, the radar signal processing apparatus 140, the communication circuit 141, the processor 142, the autonomous driving device 500, the sensor 510, the processor 530, the main processor 550, the driver 560, the communication interface 570, the image sensor 511, the depth camera 513, the engine and motor 561, the steering unit 563, and/or the brake unit 565 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 143, the memory 520 and/or the RAM 540). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

While the inventive concepts have been particularly shown and described with reference to embodiments thereof, it will be understood that various changes in form and details may be made therein without departing from the spirit and scope of the following claims.

What is claimed is:

1. A radar signal processing method based on Orthogonal Frequency Division Multiplexing (OFDM), the method comprising:
transmitting an OFDM transmission signal to at least one target;
receiving an analog reception signal reflected from the at least one target;
converting the analog reception signal into a digital reception signal;
obtaining a first velocity of the at least one target based on the digital reception signal; and
processing the digital reception signal based on the first velocity to obtain a recovery signal having reduced inter-channel interference.

2. The method of claim 1, wherein the obtaining of the first velocity comprises:
obtaining a plurality of velocity candidates;
obtaining a plurality of distance velocity map candidates corresponding to the plurality of velocity candidates;
detecting peak values of the plurality of distance velocity map candidates; and
obtaining the first velocity as a first velocity candidate corresponding to a largest peak value among the peak values, the first velocity candidate being among the plurality of velocity candidates.

3. The method of claim 2, wherein the obtaining of the plurality of velocity candidates comprises obtaining the plurality of velocity candidates according to the following equation
vₐ=v+2*Z*v_{amb},
wherein vₐ represents the plurality of velocity candidates, v represents an estimated velocity of the at least one target, Z represents an arbitrary integer, and v_{amb} represents a maximum distinguishable velocity.

4. The method of claim 2, wherein the obtaining of the plurality of distance velocity map candidates comprises obtaining the plurality of distance velocity map candidates according to the following equation
$$G ( Z ) = {F}_{{N}_{C}}^{- 1} ( {F}_{{N}_{C}} {D}_{{N}_{C}} ( - \frac{Z}{α * {N}_{C}} ) Y X ) {F}_{{N}_{S}} ,$$
wherein D_{N}_{_{C}} represents a matrix according to the following equation
$${D}_{N} ( f ) = [ \begin{matrix}1 & 0 & … & 0 \\ 0 & {e}^{j 2 π f} & … & 0 \\ ⋮ & ⋮ & ⋱ & ⋮ \\ 0 & 0 & … & {e}^{j 2 π f ( N - 1 )}\end{matrix} ] ∈ {ℂ}^{N \times N} ,$$
F_{N}_{_{C}} and F_{N}_{_{S}} each represents a matrix according to the following equation
$${F}_{N} = {\frac{1}{\sqrt{N}} [ {e}^{- j 2 π \frac{hn}{N}} ]}_{\begin{matrix}0 \leq k < N \\ 0 \leq n < N\end{matrix}} ∈ {ℂ}^{N \times N} ,$$
α represents a length ratio of 1+ a cyclic prefix of the OFDM transmission signal, X represents a 2D Fast Fourier Transform (2D-FFT) matrix of the OFDM transmission signal, Y represents a 2D-FFT matrix of the digital reception signal, [symbol] represents an elementwise division operator, each of k and n represents an integer, and N represents a natural number.

5. The method of claim 2, wherein the detecting of the peak values comprises detecting the peak values according to a Cell Averaging-Constant False Alarm Rate (CA-CFAR) algorithm.

6. The method of claim 1, wherein the processing of the digital reception signal comprises:
generating a first basis signal and a second basis signal based on the first velocity, the first basis signal including an inter-channel interference component, and the second basis signal not including the inter-channel interference component;
generating a reflection coefficient vector of the at least one target based on the first basis signal;
generating a first composite signal based on the first basis signal and the reflection coefficient vector;
generating a second composite signal based on the second basis signal and the reflection coefficient vector; and
generating the recovery signal based on the first composite signal and the second composite signal.

7. The method of claim 6, wherein the generating of the first basis signal comprises generating the first basis signal according to the following equation
$${Y}_{C}^{( i )} = \frac{1}{\sqrt{{N}_{C}}} {D}_{{N}_{C}} ( \frac{{f}_{i}^{( D )}}{{N}_{C}} ) {F}_{{N}_{C}}^{- 1} {D}_{{N}_{C}} ( - {τ}_{i} ) {XD}_{{N}_{S}} ( α * {f}_{i}^{( D )} ) ,$$
wherein D_{N}_{_{C}} represents a matrix according to the following equation
$${D}_{N} ( f ) = [ \begin{matrix}1 & 0 & … & 0 \\ 0 & {e}^{j 2 π f} & … & 0 \\ ⋮ & ⋮ & ⋱ & ⋮ \\ 0 & 0 & … & {e}^{j 2 π f ( N - 1 )}\end{matrix} ] ∈ {ℂ}^{N \times N} ,$$
F_{N}_{_{C}} represents a matrix according to the following equation
$${F}_{N} = {\frac{1}{\sqrt{N}} [ {e}^{- j 2 π \frac{kn}{N}} ]}_{\begin{matrix}0 \leq k < N \\ 0 \leq n < N\end{matrix}} ∈ {ℂ}^{N \times N} ,$$
fᵢ^{(D)} represents a normalized velocity component of an i-th target according to the following equation
$${f}_{i}^{( D )} = \frac{2 * {f}_{c} * {v}_{i}}{{c}_{0}} , i = 0 , 1 , … , \vert T \vert - 1 ,$$
τᵢ represents a normalized distance component of the i-th target according to the following equation
$${τ}_{i} = \frac{2 * {d}_{i}}{{c}_{0}} * {f}_{s} , i = 0 , 1 , … , \vert T \vert - 1 ,$$
Y_{C}⁽ⁱ⁾ represents the first basis signal, X represents a 2D Fast Fourier Transform (2D-FFT) matrix of the OFDM transmission signal, c₀ represents a velocity of light, f_{c} represents a transmission frequency of the OFDM transmission signal, and vᵢ represents the first velocity, dᵢ represents a distance of the i-th target, fₛ represents a subcarrier spacing of the OFDM transmission signal, α represents a length ratio of 1+ a cyclic prefix of the OFDM transmission signal, each of k, n and i represents an integer, N represents a natural number, and |T| represents the number of elements of a set T.

8. The method of claim 7, wherein the generating of the first composite signal comprises generating the first composite signal according to the following equation
Y_{C}=Σᵢ₌₀^{|T|×1}αᵢY_{C}⁽ⁱ⁾,
wherein Y_{C} represents the first composite signal, and αᵢ represents the i-th component of the reflection coefficient vector.

9. The method of claim 6, wherein the generating of the second basis signal comprises generating the second basis signal according to the following equation
$${Y}_{R}^{( i )} = \frac{1}{\sqrt{{N}_{C}}} {F}_{{N}_{C}}^{- 1} {D}_{{N}_{C}} ( - {τ}_{i} ) {XD}_{{N}_{S}} ( α * {f}_{i}^{( D )} ) ,$$
wherein D_{N}_{_{C}} represents a matrix according to the following equation
$${D}_{N} ( f ) = [ \begin{matrix}1 & 0 & … & 0 \\ 0 & {e}^{j 2 π f} & … & 0 \\ ⋮ & ⋮ & ⋱ & ⋮ \\ 0 & 0 & … & {e}^{j 2 π f ( N - 1 )}\end{matrix} ] ∈ {ℂ}^{N \times N} ,$$
F_{N}_{_{C}} represents a matrix according to the following equation
$${F}_{N} = {\frac{1}{\sqrt{N}} [ {e}^{- j 2 π \frac{kn}{N}} ]}_{\begin{matrix}0 \leq k < N \\ 0 \leq n < N\end{matrix}} ∈ {ℂ}^{N \times N} ,$$
fᵢ^{(D)} represents a normalized velocity component of an i-th target according to the following equation
$${f}_{i}^{( D )} = \frac{2 * {f}_{c} * {v}_{i}}{{c}_{0}} , i = 0 , 1 , … , \vert T \vert - 1 ,$$
τᵢ represents a normalized distance component of the i-th target according to the following equation
$${τ}_{i} = \frac{2 * {d}_{i}}{{c}_{0}} * {f}_{s} , i = 0 , 1 , … , \vert T \vert - 1 ,$$
Y_{R}⁽ⁱ⁾ represents the second basis signal, X represents a 2D Fast Fourier Transform (2D-FFT) matrix of the OFDM transmission signal, c₀ represents a velocity of light, f_{c} represents a transmission frequency of the OFDM transmission signal, and vᵢ represents the first velocity, dᵢ represents a distance of the i-th target, fₛ represents a subcarrier spacing of the OFDM transmission signal, α represents a length ratio of 1+ a cyclic prefix of the OFDM transmission signal, each of k, n and i represents an integer, N represents a natural number, and |T| represents the number of elements of a set T.

10. The method of claim 9, wherein the generating of the second composite signal comprises generating the second composite signal according to the following equation.
Y_{R}=Σᵢ₌₀^{|T|×1}αᵢY_{R}⁽ⁱ⁾,
wherein Y_{R} represents the second composite signal, and αᵢ represents the i-th component of the reflection coefficient vector.

11. The method of claim 6, wherein the generating of the reflection coefficient vector comprises generating the reflection coefficient according to the following equation
\vec{a}=(Q^{T}Q)⁻¹Q^{T}\vec{q}.

12. The method of claim 6, wherein generating the recovery signal comprises generating the recovery signal according to the following equation
$${Y}_{RC} = Y - {Y}_{C} + {Y}_{R} ,$$
wherein Y_{RC} represents the recovery signal, Y represents a 2D-FFT matrix of the digital reception signal, Y_{C} represents the first composite signal, and Y_{R} represents the second composite signal.

13. A radar signal processing apparatus comprises:
processing circuitry configured to,
transmit an Orthogonal Frequency Division Multiplexing (OFDM) transmission signal to at least one target,
receive an analog communication reception signal reflected from the at least one target,
convert the analog communication reception signal into a digital reception signal,
obtain a first velocity of the at least one target based on the digital reception signal, and
process the digital reception signal based on the first velocity to obtain a recovery signal having reduced inter-channel interference.

14. The radar signal processing apparatus of claim 13, wherein the processing circuitry is configured to:
obtain a plurality of velocity candidates,
obtain a plurality of distance velocity map candidates corresponding to the plurality of velocity candidates,
detect peak values of the plurality of distance velocity map candidates, and
obtain the first velocity as a first velocity candidate corresponding to a largest peak value among the peak values, the first velocity candidate being among the plurality of velocity candidates.

15. The radar signal processing apparatus of claim 14, wherein the processing circuitry is configured to obtain the plurality of velocity candidates according to the following equation
vₐ=v+2*Z*v_{amb},
wherein vₐ represents the plurality of velocity candidates, v represents an estimated velocity of the at least one target, Z represents an arbitrary integer, and v_{amb} represents a maximum distinguishable velocity.

16. The radar signal processing apparatus of claim 14, wherein the processing circuitry is configured to obtain the plurality of distance velocity map candidates according to the following equation
$$G ( Z ) = {F}_{{N}_{C}}^{- 1} ( {F}_{{N}_{C}} {D}_{{N}_{C}} ( - \frac{Z}{α * {N}_{C}} ) Y X ) {F}_{{N}_{S}} ,$$
wherein D_{N}_{_{C}} represents a matrix according to the following equation
$${D}_{N} ( f ) = [ \begin{matrix}1 & 0 & … & 0 \\ 0 & {e}^{j 2 π f} & … & 0 \\ ⋮ & ⋮ & ⋱ & ⋮ \\ 0 & 0 & … & {e}^{j 2 π f ( N - 1 )}\end{matrix} ] ∈ {ℂ}^{N \times N} ,$$
F_{N}_{_{C}} and F_{N}_{_{S}} each represents a matrix according to the following equation
$${F}_{N} = {\frac{1}{\sqrt{N}} [ {e}^{- j 2 π \frac{kn}{N}} ]}_{\begin{matrix}0 \leq k < N \\ 0 \leq n < N\end{matrix}} ∈ {ℂ}^{N \times N} ,$$
α represents a length ratio of 1+ a cyclic prefix of the OFDM transmission signal, X represents a 2D Fast Fourier Transform (2D-FFT) matrix of the OFDM transmission signal, Y represents a 2D-FFT matrix of the digital reception signal, [symbol] represents an elementwise division operator, each of k and n represents an integer, and N represents a natural number.

17. The radar signal processing apparatus of claim 14, wherein the processing circuitry is configured to detect the peak values according to a Cell Averaging-Constant False Alarm Rate (CA-CFAR) algorithm.

18. The radar signal processing apparatus of claim 13, wherein the processing circuitry is configured to:
generate a first basis signal and a second basis signal based on the first velocity, the first basis signal including an inter-channel interference component, and the second basis signal not including the inter-channel interference component,
generate a reflection coefficient vector of the at least one target based on the first basis signal,
generate a first composite signal based on the first basis signal and the reflection coefficient vector,
generate a second composite signal based on the second basis signal and the reflection coefficient vector, and
generate the recovery signal based on the first composite signal and the second composite signal.

19. A computer-readable non-transitory storage medium storing instructions that, when executed by at least one processor, cause the at least one processor to perform orthogonal frequency division multiplexing (OFDM) radar signal processing, wherein the OFDM radar signal processing comprising:
transmitting an OFDM transmission signal to at least one target;
receiving an analog reception signal reflected from the at least one target;
converting the analog reception signal into a digital reception signal;
obtaining a first velocity of the at least one target based on the digital reception signal; and
processing the digital reception signal based on the first velocity to obtain a recovery signal having reduced inter-channel interference.

20. The computer-readable non-transitory storage medium of claim 19, wherein the obtaining of the first velocity comprises:
obtaining a plurality of velocity candidates;
obtaining a plurality of distance velocity map candidates corresponding to the plurality of velocity candidates;
detecting peak values of the plurality of distance velocity map candidates; and
obtaining the first velocity as a first velocity candidate corresponding to a largest peak value among the peak values, the first velocity candidate being among the plurality of velocity candidates.
